(19) United States
(12) Patent Application Publication
(10) Pub. No.: US 2009/0165646 A1
(43) Pub. Date: Jul. 2, 2009

(54) EFFLUENT GAS RECOVERY PROCESS FOR SILICON PRODUCTION

(76) Inventors: Sarang Gadre, Bear, DE (US); Shawn Bratt, Hockessin, DE (US)

Correspondence Address: AIR LIQUIDE;Intellectual Property, 2700 POST OAK BOULEVARD, SUITE 1800, HOUSTON, TX, 77056, US

(21) Appl. No.: 11/967,655

(22) Filed: Dec. 31, 2007

(51) Int. Cl. B01D 53/22; B01D 50/00

(52) U.S. Cl. 95/55; 55/385.1

(57) ABSTRACT

Effluent gas from a polysilicon reactor is directed to a gas separation membrane with a permeate gas being recycled to the reactor and the retentate being chilled with a cryogenic condenser using liquid cryogen. Liquid cryogen vaporized by the hot effluent gas may be stored or used to seal and/or chill the reactor or blanket a Si feed to a SiHCl3 reactor.

### CROSS-REFERENCE TO RELATED APPLICATIONS

None

### BACKGROUND

Effluent gas recovery from silicon production process is important operation as it can reduce the cost of production. For a silicon production using Siemens method, effluent gas leaving the deposition reactor typically contains large quantities of hydrogen. This amount can vary based on set of operating conditions.

Some have proposed to recycle some of the hydrogen from the effluent gas using a gas separation membrane, such as disclosed by U.S. Pat. No. 4,941,893.

### SUMMARY

There is provided a method for recycling effluent gas from a polysilicon production reactor that includes the following steps. An effluent gas is directed from a polysilicon reactor to a gas separation unit comprising at least one gas separation membrane, the effluent gas comprising SiHCl₃, SiCl₄, HCl, and H₂. A recycle gas is recovered from a permeate side of the membrane, the recycle gas comprising H₂ permeated through the membrane from the effluent gas. The recycle gas is directed to the polysilicon reactor. A retentate gas is recovered from the membrane, the retentate gas comprising SiHCl₃, SiCl₄, HCl, and H₂. The retentate gas is chilled at a first cryogenic condensation unit utilizing a liquid cryogen to absorb heat from the retentate gas thereby vaporizing at least a portion of the liquid cryogen and producing a first condensate comprising SiHCl3, SiCl4, and HCl from the retentate gas.

The disclosed method may include one or more of the following aspects.
the condensed SiHCl3, SiCl4, and HCl are directed to a SiHCl3 production process.
purified SiHCl3 is obtained from the SiHCl3 production process and a flow of the purified SiHCl3 is directed towards the reactor.
the step of chilling the retentate gas at a first cryogenic condensation unit comprises the step of chilling the retentate gas at a first cryogenic condenser to produce a first condensate comprising SiHCl3, SiCl4, and HCl.
the first condensate is directed to a SiHCl3 production process.
the step of chilling the retentate gas at a first cryogenic condensation unit further comprises the steps of:
   compressing a first non-condensate comprising a non-condensed portion of the retentate gas from the first cryogenic condenser, the first non-condensate comprising a majority of H2 and minor amounts of SiHCl3, SiCl4, and HCl; and
   chilling the compressed first non-condensate at a second cryogenic condenser thereby producing a second condensate comprising SiHCl3, SiCl4, and HCl from the compressed first non-condensate.
the second condensate is directed from the second cryogenic condenser to a SiHCl3 production process.
purified SiHCl3 is obtained from the SiHCl3 production process a flow of the purified SiHCl3 is directed towards the reactor.
the SiHCl3 production process comprises directing the first and second condensates to a distillation unit and obtaining the flow of purified SiHCl3 from the distillation unit.
the SiHCl3 production process further comprises the steps of:
   stripping H2 from a second non-condensate comprising a majority of H2 and a minor amount of SiHCl3, SiCl₄, and HCl from a non-condensed portion of the compressed first non-condensate;
   chilling the stripped second non-condensate to produce gaseous HCl and a third condensate comprising SiHCl3 and SiCl₄; and
   directing the third condensate to the distillation unit.
the SiHCl3 production process further comprises the steps of:
   feeding Si and the gaseous HCl to a first SiHCl3 reactor thereby producing impure SiHCl3;
   purifying the impure SiHCl3 at a purification unit to produce a SiHCl3 feed;
   directing the SiHCl3 feed to the distillation unit.
the Si is fed to the first SiHCl3 reactor under a gaseous N2 blanket obtained from the first and/or second cryogenic condensers.
the SiHCl3 production process further comprises the steps of:
   feeding Si, H2, and a SiCl₄-rich fraction from the distillation unit to a second SiHCl3 reactor in the presence of CuCl thereby producing impure SiHCl3; and
   purifying the impure SiHCl3 from the second SiHCl3 reactor at the distillation unit.
the reactor is cooled with a portion of the vaporized liquid cryogen.
the reactor is blanketed with a portion of the vaporized liquid cryogen to reduce the infiltration of oxygen into the reactor.

There is also disclosed a system for recycling effluent gas from a polysilicon production reactor including: a gas separation unit and a first cryogenic condenser. The gas separation unit includes at least one gas separation membrane, an inlet, a permeate outlet, and a retentate outlet. The inlet is adapted and configured to fluidly communicate with an effluent gas outlet of a polysilicon reactor. The permeate outlet is adapted and configured to fluidly communicate with a reactant feed inlet of the polysilicon reactor. The first cryogenic condenser has a permeate gas inlet, a liquid nitrogen inlet, a vaporized cryogen outlet, a condensate outlet, and a non-condensate outlet. The permeate gas inlet is in fluid communication with the retentate outlet. The first cryogenic condenser is adapted and configured to cool effluent gas obtained from the retentate gas outlet by vaporizing liquid nitrogen from the liquid nitrogen inlet.

The disclosed system may include one or more of the following aspects:
The system further includes:
   a compressor adapted and configured to receive a non-condensate from the non-condensate outlet of the first condenser; and
   a second cryogenic condenser having non-condensate inlet, a liquid nitrogen inlet, a vaporized cryogen outlet, a condensate outlet, and a non-condensate outlet, the non-condensate inlet being in fluid communication with the compressor, wherein the second cryogenic condenser is adapted and configured to cool effluent gas from the compressor by vaporizing liquid nitrogen from the second condenser liquid nitrogen inlet.
The system further includes a distillation unit having inlets in fluid communication with the condensate outlets of the first and second cryogenic condensers, the distillation unit being adapted and configured to provide a purified SiHCl3 feed to be directed to the reactor.
The system further includes:
   an adsorption unit adapted and configured to strip H2 from a SiCl4, SiHCl3, HCl, and H2 containing vapor from the non-condensate outlet of the second condenser;
   a third cryogenic condenser having an inlet, a gaseous HCl outlet, and a condensate outlet, the third condenser inlet being adapted and configured to condense SiCl4 and SiHCl3 from a vapor from the adsorption unit;
   a first SiHCl3 reactor having reactant inlets in fluid communication with a source of particulate Si and the gaseous HCl outlet;
   a purification unit having an inlet and outlet, the purification unit inlet being adapted and configured to receive impure SiHCl3 from the first SiHCl3 reactor, the purification unit outlet being in fluid communication with an inlet of the distillation unit.
the source of particulate Si is adapted and configured to receive a gaseous N2 blanket from first and/or second cryogenic condenser.
The system further includes a second SiHCl3 reactor having reactant inlet and a product outlet, the second SiHCl3 reactor reactant inlet being in fluid communication with a source of particulate Si, a source of H2, and a SiCl₄ outlet of the distillation unit, the second SiHCl3 reactor being adapted and configured to react Si and H2 from said sources with SiCl₄ from said SiCl₄ outlet in the presence of CuCl to produce SiHCl3, the second SiHCl3 reactor product outlet being in fluid communication with an inlet of the distillation unit.
the purified SiHCl3 is stored in a storage vessel blanketed with vaporized liquid cryogen to reduce the infiltration of oxygen into the vessel.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of an embodiment of the system and method of the invention.

FIG. 2 is a schematic of another embodiment of the system and method of the invention including two condensers.

FIG. 3 is a schematic of another embodiment of the system and method of the invention including two condensers and a SiHCl3 production process.

### DESCRIPTION OF PREFERRED EMBODIMENTS

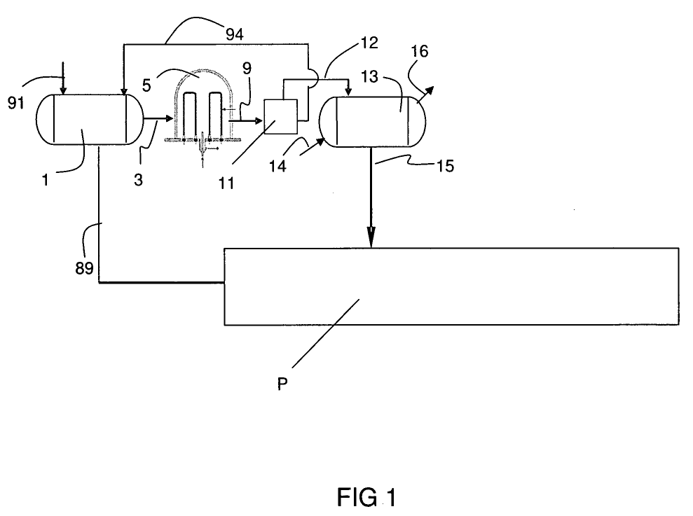

As best shown in FIG. 1, in one embodiment a trichlorosilane (TCS) and H2 feed 3 from feedstock tank 1 are fed to polysilicon reactor 5 where they react according to the below reaction:

SiHCl₃+H₂ [symbol] Si+3HCl

The following equilibrium reactions also play a role:

2SiHCl₃ [symbol] Si+SiCl₄+2HCl(1050-1200° C.)

4SiHCl₃ [symbol] 3SiCl₄+2H₂+Si

SiHCl₃+HCl [symbol] SiCl₄+H₂

TCS is also in equilibrium with SiCl₂, a key intermediate:

SiHCl₃ [symbol] SiCl₂+HCl

While the schematic crudely depicts a bell jar shape, the invention is equally applicable to Siemens-type bell jar reactors and fluidized bed reactors. A wall temperature of the reactor is maintained at a temperature of about 575° C. and a deposition temperature is maintained at a temperature of about 1100° C. One of ordinary skill in the art will recognize that the TCS and H2 need not be fed to reactor 5 from a feedstock tank 1. Rather, each of the reactants may be fed directly to reactor 5 without the intermediary feedstock tank 1. If the reactor 5 is being used to make electronic grade polysilicon, it is typically operated at a pressure of about 5 psig. In the case of solar grade polysilicon, it is operated at a pressure of 75 psig or greater.

Effluent gas stream 9 containing silicon tetrachloride (STC), an amount of non-reacted TCS, HCl, and H2 is directed to gas separation membrane 11 where it is separated into a H₂-rich stream and a H₂-lean stream 12 containing TCS, STC, HCl, and a minor amount of H2. The H2-lean stream 12 is directed to TCS purification system P which produces purified TCS stream 89. The H2-rich stream 94 is directed to feedstock tank 1. One of ordinary skill in the art will recognize that feedstock tank 1 is not essential to practice of the invention and that the H2 recycle 94 and H2 make up 91 may instead be fed directly to reactor 5.

H2-lean stream 12 is directed to cryogenic condenser 13 utilizing a liquid N2 feed 14 to chill the stream 12 down to a temperature of about −40° C. This will condense a large portion of chlorosilanes present in stream 12. Liquid N2 vaporized at condenser 13 produces gaseous N2 stream 16. Stream 16 may be stored and/or directed to a point of use at the polysilicon production facility. For example, the gaseous N2 may be used to cool down or inert reactor 5. The condensate 15, containing a mixture of TCS, STC, and dissolved HCl, is directed to TCS production process P. A stream of purified TCS 89 produced by process P is directed to feedstock tank 1. Again, one of ordinary skill in the art will recognize that feedstock tank 1 is not essential to practice of the invention and that the TCS stream 89 may instead be fed directly to reactor 5.

Cryogenic condensers are well known heat exchange devices having a shell and tube configuration that exchange heat between a liquified cryogen and a fluid such as a gas. Suitable cryogenic condensers may be obtained from the DTA subsidiary of Air Liquide located in Grenoble, France as well as from Praxair, Inc. located in Danbury, Conn., BOC Gases, a subsidiary of Linde AG located in Murray Hill, N.J., or Air Products located in Allentown, Pa.

Since the H2 permeation rate through the membrane 11 is much faster than any other species present in the effluent gas stream 9, the permeate has a negligible amount of undesirable impurities. This makes it suitable for sending the H2 recycle 94 to the deposition reactor 5 without further treatment.

In one particular example for 1000 metric tons/year silicon production using Siemens process, a simulation was performed in HYSYS and reduction in effluent flows using membranes was found to be as much as 80%. Thus resulting 20% membrane retentate stream was cooled with the liquid nitrogen based cryogenic condensers such that the amount of evaporated nitrogen leaving the condenser is only about 250 Nm3/hr compared to nearly 8000 Nm3/hr obtained in the absence of a membrane. This amount of nitrogen is much more typical of the nitrogen process stream needed in a Siemens process either for use as sealant gas or cooling the bell jar reactor at the end of the process or purging the metallurgical grade silicon to remove air traces.

Thus, the advantages of the invention are threefold. First, by using membrane 11 as described, the amount of compression needed is reduced. Second, because the mass flow rate of the H2-lean stream 12 is reduced in comparison to gas effluent stream 9, the size and the cost of most downstream operations are reduced. Third, with this reduction in mass flow rate, one can use a liquid N2 based cryogenic condenser such that the vaporized N2 from the condenser may be used directly as a process stream thus eliminating the mechanical refrigeration that would otherwise be needed in absence of the use of cryogenic condenser 13.

Suitable gas separation membranes 11 include those chemically resistant to TCS, STC, H2, and HCl and which exhibit an enhanced permeance of H2 in comparison to the TCS, STC, and HCl. Such membranes can be configured in a variety of ways: sheet, tube, hollow fiber, etc. One of ordinary skill in the art will recognize that the permeate “side” of a membrane does not necessarily mean one and only one side of a membrane. Rather, in the case of membranes include a plurality of hollow fibers, the permeate “side” actually is considered to be the plurality of sides of the individual hollow fibers that are opposite to the sides to which the effluent gas 9 is introduced.

Preferably, the gas separation membrane of gas separation unit 11 is a spiral flat sheet membrane or hollow fiber membrane made of a polymeric material such as a polysulfone, a polyether sulfone, a polyimide, a polyaramide, a polyamide-imide, and blends thereof.

One preferred type of hollow fiber membrane includes those disclosed by U.S. Published Patent Application 2006/0156920 A1, the contents of which are enclosed herein in their entirety. Those hollow polymeric fibers include polyimides, polyamides, polyamide-imides, and blends thereof. They includee an outer selective layer.

The polyimide contains the repeating units as shown in the following formula (I):

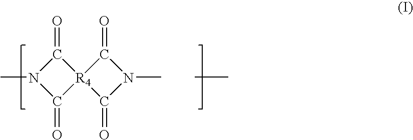

in which R₁ of formula (I) is a moiety having a composition selected from the group consisting of formula (A), formula (B), formula (C), and mixtures thereof, and

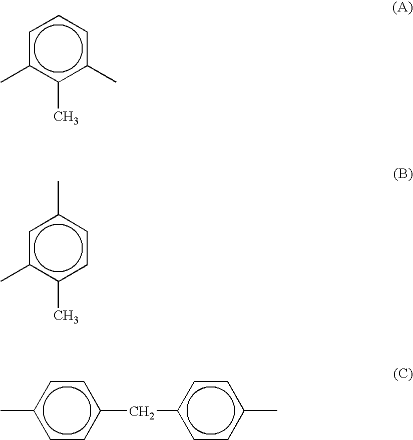

in which R₄ of formula (I) is a moiety having a composition selected from the group consisting of formula (Q), formula (S), formula (T) and mixtures thereof,

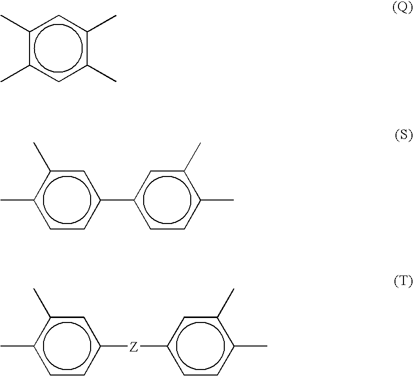

in which Z of formula (T) is a moiety selected from the group consisting of formula (L), formula (M), formula (N) and mixtures thereof.

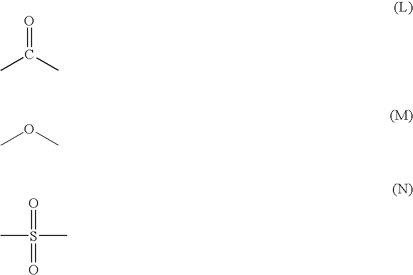

In one preferred embodiment, the polyimide component of the blend that forms the selective layer of the membrane has repeating units as shown in the following formula (Ia):

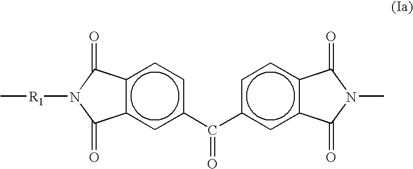

In this embodiment, moiety R₁ of formula (Ia) is of formula (A) in 0-100% of the repeating units, of formula (B) in 0-100% of the repeating units, and of formula (C) in a complementary amount totaling 100% of the repeating units. A polymer of this structure is available from HP Polymer GmbH under the trade name P84. P84 is believed to have repeating units according to formula (Ia) in which R₁ is formula (A) in about 16% of the repeating units, formula (B) in about 64% of the repeating units and formula (C) in about 20% of the repeating units. P84 is believed to be derived from the condensation reaction of benzophenone tetracarboxylic dianhydride (BTDA, 100 mole %), with a mixture of 2,4-toluene diisocyanate (2,4-TDI, 64 mole %), 2,6-toluene diisocyanate (2,6-TDI, 16 mole %) and 4,4′-methylene-bis(phenyl)socyanate) (MDI, 20 mole %).

The polyimide (that is preferably formed in a known way to provide an outer selective layer) comprises repeating units of formula (Ib):

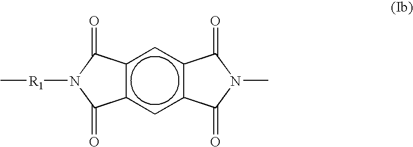

In one preferred embodiment, the polyimide is of formula (Ib) and R₁ of formula (Ib) is a composition of formula (A) in about 0-100% of the repeating units, and of formula (B) in a complementary amount totaling 100% of the repeating units.

In yet another embodiment, the polyimide is a copolymer comprising repeating units of both formula (Ia) and (Ib) in which units of formula (Ib) constitute about 1-99% of the total repeating units of formulas (Ia) and (Ib). A polymer of this structure is available from HP Polymer GmbH under the trade name P84HT. P84HT is believed to have repeating units according to formulas (Ia) and (Ib) in which the moiety R₁ is a composition of formula (A) in about 20% of the repeating units and of formula (B) in about 80% of the repeating units, and, in which repeating units of formula (Ib) constitute about 40% of the total of repeating units of formulas (Ia) and (Ib). P84HT is believed to be derived from the condensation reaction of benzophenone tetracarboxylic dianhydride (BTDA, 60 mole %) and pyromellitic dianhydride (PMDA, 40 mole %) with 2,4-toluene diisocyanate (2,4-TDI, 80 mole %) and 2,6-toluene diisocyanate (2,6-TDI, 20 mole %). The polyamide polymer of the blend that forms the selective layer of the membrane comprises the repeating units of the following formula (II):

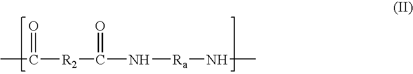

in which Rₐ is a moiety having a composition selected from the group consisting of formulas

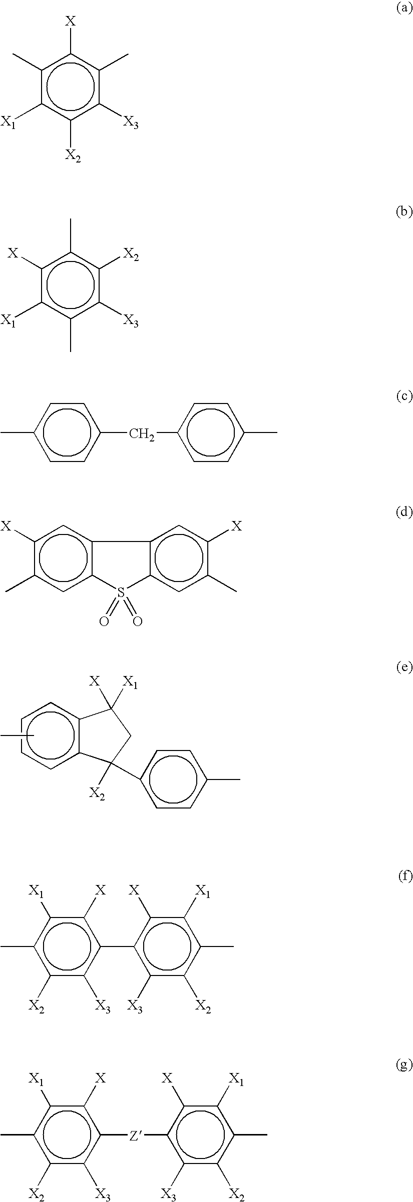

wherein Z′ of formula (g) is a moiety represented by the formula

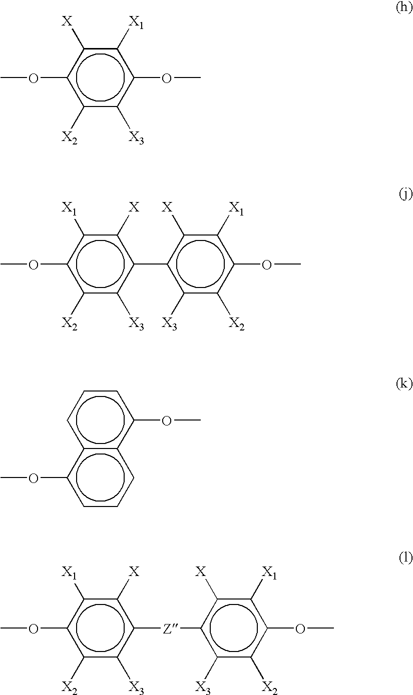

and mixtures thereof, and
in which X, X₁, X₂, and X₃ of formulas a, b, d, e, f, g, h, j, and, l independently are hydrogen or an alkyl group having 1 to 6 carbon atoms, and Z″ of formula (I) is selected from the group consisting of:

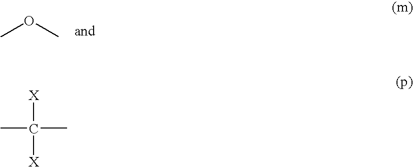

in which X of formula (p) is a moiety as described above.

R₂ of formula (II) is a moiety having a composition selected from the group consisting of formulas:

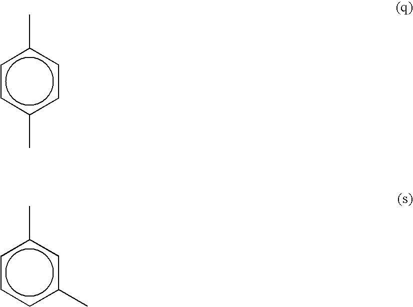

and mixtures thereof.

The polyamide-imide polymers of the blend that forms the selective layer of the membrane comprises the repeating units of formula (III); and/or a combination of the repeating units of formulas (I) and (II), (I) and (III), (II) and (III), and/or (I), (II), and (III).

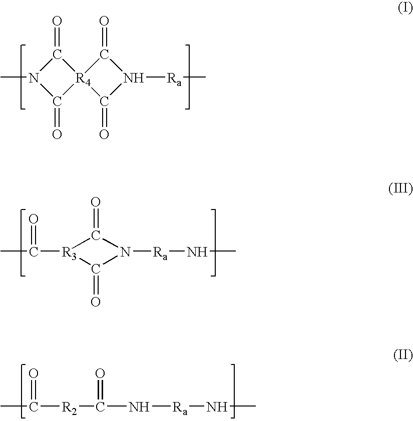

in which Rₐ, R₂, and R₄ are the same as described above, and R₃ is

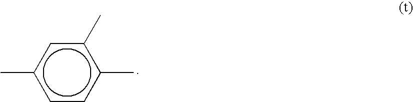

Membranes made from a blend of a polyimide or polyimides with a polyamide or polyamides, the ratio of polyimide to polyamide should preferably be at least 1:1, and more preferably, at least 2:1.

In the case of membranes made from a blend of a polyimide or polyimides with a polyamide-imide or polyamide-imides, the ratio of polyimide to polyamide-imide should preferably, be at least 1:1, and more preferably at least 2:1.

In the case of membranes made from a blend of a polyimide or polyimides with a polyamide or polyamides, and a polyamide-imide or polyamide-imides, the blend should preferably contain between 20-80% polyimide.

Surprising, the blends of this invention are homogeneous over a broad range of compositions. The miscibility of the blends of this invention may be confirmed by the presence of single compositional dependent glass transition temperature lying between those of the constituent blend components. The glass transition temperature can be measured by Differential Scanning Calorimetry or Dynamic Mechanical Analysis.

The polyimides described above are made by methods well known in the art. The polyimides can, for example, be conveniently made by polycondensation of an appropriate diisocyanate with approximately an equimolar amount of an appropriate dianhydride. Alternatively, the polyimides can be, for example, made by polycondensation of equimolar amounts of a dianhydride and a diamine to form a polyamic acid followed by chemical or thermal dehydration to form the polyimide. The diisocyanates, diamines, and dianhydrides useful for making the polyimides of interest are usually available commercially. The polyimides are typically prepared by the latter diamine process because the diamines are more readily available than the corresponding diisocyanates.

The polyamides described above can be made conveniently by polycondensation of an appropriate diamine or diamines with approximately an equimolar amount of an appropriate diacid chloride or mixtures of diacid chlorides by methods well known in the art.

The polyamide-imide polymers described above can be made conveniently by polycondensation of an appropriate diamine with approximately an equimolar amount of an appropriate triacid anhydride/chloride (i.e., repeating units of formula (III)).

In the case of a mixture of polyamide/polyamide-imides, the polyamide-imides described herein can be made conveniently by:
1) polycondensation of an appropriate diamine or diamines with an equimolar amount a mixture of dianhydride and diacid chloride mixture (i.e., repeating units of formulas (I) and (II));
2) by polycondensation of an appropriate diamine or diamines with an equimolar amount of a mixture of dianhydride and triacid anhydride chloride (i.e., repeating units of formulas (I) and (III));
3) by polycondensation of an appropriate diamine or diamines with an equimolar amount of a mixture of diacid-chloride and triacid anhydride/chloride (i.e., repeating units of formulas II and II); or
4) by polycondensation of an appropriate diamine or diamines with an equimolar amount of a mixture of dianhdride, diacid chloride, and triacid anhydride/chloride (i.e., repeating units of formulas I, II, and III).

The polyimides, polyamides, and polyamide-imides should be of suitable molecular weight to be film forming and pliable so as to be capable of being formed into continuous films or membranes. The polymers of this invention preferably have a weight average molecular weight within the range of about 20,000, to about 400,000, and more preferably, about 50,000 to about 300,000.

Another type of polymeric material particularly useful in the membrane includes an amorphous polymer of perfluoro-2,2-dimethyl-1,3-dioxole, as disclosed in U.S. Pat. No. 5,051,114, the contents of which are incorporated herein in their entirety. It may be a homopolymer of perfluoro-2,2-dimethyl-1,3-dioxole. It may instead be a copolymer of perfluoro-2,2-dimethyl-1,3-dioxole, including copolymers having a complementary amount of at least one monomer selected from the group consisting of tetrafluoroethylene, perfluoromethyl vinyl ether, vinylidene fluoride and chlorotrifluoroethylene. Preferably, the polymer is a dipolymer of perfluoro-2,2-dimethyl-1,3-dioxole and a complementary amount of tetrafluoroethylene, especially such a polymer containing 65-99 mole % of perfluoro-2,2-dimethyl-1,3-dioxole. The amorphous polymer preferably has a glass transition temperature of at least 140.degree. C., and more preferably at least 180.degree. C. Examples of dipolymers are described in further detail in U.S. Pat. No. 4,754,009, the contents of which are incorporated herein in their entirety.

Another type of polymeric material particularly useful in the membrane includes a polymer available under the trade name MATRIMID 5218, a polymer available under the trade name ULTEM 1000, and blends thereof as disclosed in U.S. Pat. No. 5,248,319. MATRIMID 5218 is the polymeric condensation product of 3,3′,4,4′-benzophenone tetracarboxylic dianhydride and 5(6)-amino-1-(4′-aminophenyl)-1,3,3′-trimethylindane, commercially available from Ciba Specialty Chemicals Corp. Ultem 1000 may be obtained from a wide variety of commercial sources, including Polymer Plastics Corp. located in Reno, Nev. and Modern Plastics located in Bridgeport, Conn. Ultem 1000 has the formula shown below.

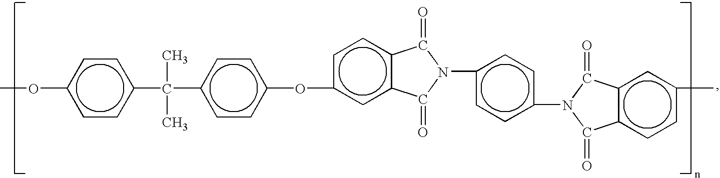

The membranes of the invention typically have continuous channels for fluid flow extending between the exterior and interior surfaces. These pores have an average cross-sectional diameter less than about 20,000 Angstroms, preferably less than about 1,000 or 5,000 Angstroms. The hollow fibers may have outside diameters of about 20 to 1,000 microns, generally about 50 to 1,000 microns, and have walls of at least about 5 microns in thickness, generally about 50 to about 1,000 microns thick. The wall thickness in some hollow fibers may be up to about 200 or 300 microns. The coating may have a thickness ranging from about 0.01 to about 10 microns and preferably has a thickness of about 0.05 to about 2 microns.

In the case of hollow fiber membranes, in order to provide desirable fluxes through the hollow fibers, particularly using those hollow fibers having walls at least about 50 microns in thickness, the hollow fibers may have a substantial void volume. Voids are regions within the walls of the hollow fibers which are vacant of the material of the hollow fibers. Thus, when voids are present, the density of the hollow fiber is less than the density of the bulk material of the hollow fiber. Often, when voids are desired, the void volume of the hollow fibers is up to about 90, generally about 10 to 80, and sometimes about 20 or 30 to 70, percent based on the superficial volume, i.e., the volume contained within the gross dimensions, of the hollow fiber or flat sheet.

The density of the hollow fiber can be essentially the same throughout its thickness, i.e., isotropic, but the hollow fiber is preferably characterized by having at least one relatively dense region within its thickness in barrier relationship to fluid flow through the wall of the hollow fiber, i.e., the hollow fiber is anisotropic.

One of ordinary skill in the art will recognize that well known system parameters such as the number of fibers can be adjusted such that recycle 94 leaving the permeate side of the membrane 11 has a composition suitable for the deposition reactor.

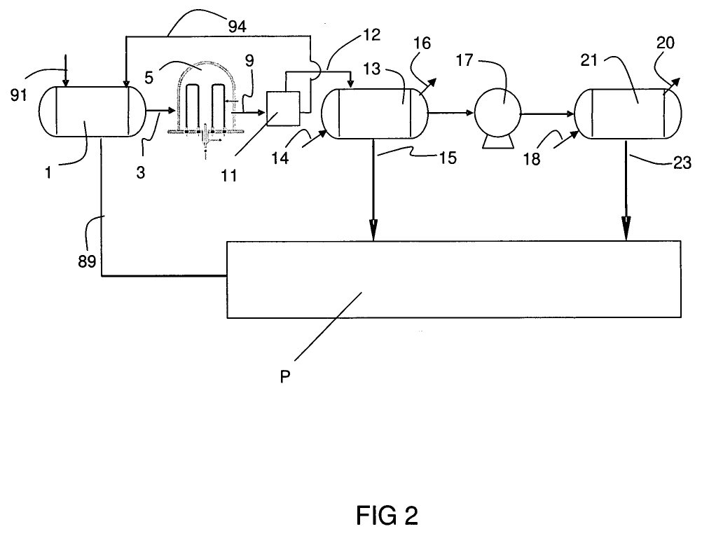

As best illustrated in FIG. 2, in another embodiment where like reference characters denote like elements, non-condensed effluent from cryogenic condenser 13 is compressed to a pressure of about 153 psig and directed to cryogenic condenser 21 which further condenses chlorosilanes and some HCl. Cryogenic condenser 21 typically cools the non-condensed portion of the compressed effluent gas to a temperature of about −60° C. Condensates 15, 23 are directed to SiHCl3 production process P. As in the embodiment of FIG. 1, liquid N2 feeds 14, 18 produce vaporized N2 16, 20 for storage and/or onsite use as a sealant or coolant gas for reactor 5.

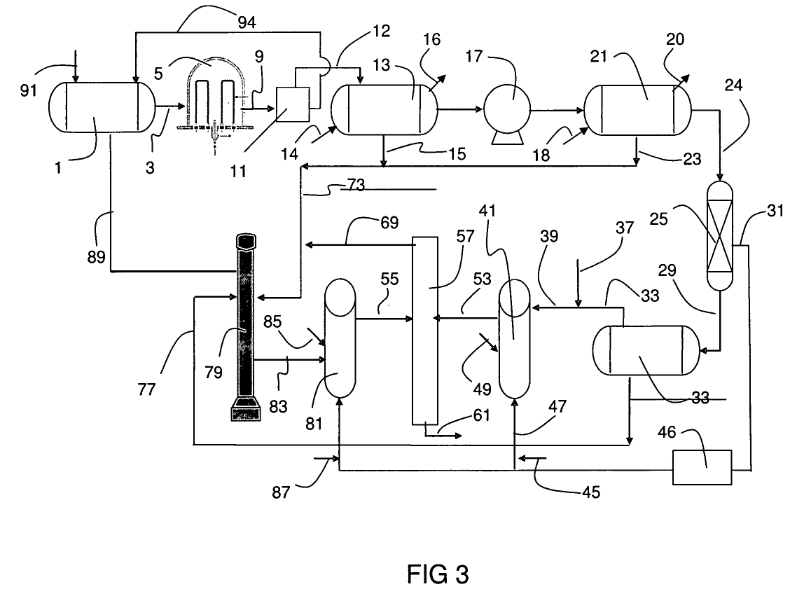

As best shown in FIG. 3, in another embodiment further details regarding the TCS purification are described where like reference characters denote like elements, TCS and H2 feed 3 from feedstock tank 1 are fed to polysilicon reactor 5 where they react according to the below reaction:

SiHCl₃+H₂ [symbol] Si+3HCl

The following equilibrium reactions also play a role:

2SiHCl₃ [symbol] Si+SiCl₄+2HCl(1050-1200° C.)

4SiHCl₃ [symbol] 3SiCl₄+2H₂+Si

SiHCl₃+HCl [symbol] SiCl₄+H₂+H₂

TCS is also in equilibrium with SiCl₂, a key intermediate:

SiHCl₃ [symbol] SiCl₂+HCl

While the schematic crudely depicts a bell jar shape, the invention is equally applicable to Siemens-type bell jar reactors and fluidized bed reactors. A wall temperature of the reactor is maintained at a temperature of about 575° C. and a deposition temperature is maintained at a temperature of about 1125° C. One of ordinary skill in the art will recognize that the TCS and H2 need not be fed to reactor 5 from a feedstock tank 1. Rather, each of the reactants may be fed directly to reactor 5 without the intermediary feedstock tank 1. If the reactor 5 is being used to make electronic grade polysilicon, it is typically operated at a pressure of about 5 psig. In the case of solar grade polysilicon, it is operated at a pressure of 75 psig or greater.

Effluent gas stream 9 containing silicon tetrachloride (STC), an amount of non-reacted TCS, HCl, and H2 is directed to gas separation membrane 11 where it is separated into a H₂-rich stream and a H₂-lean stream 12 containing TCS, STC, HCl, and a minor amount of H2.

H2-lean stream 12 is condensed in two stages as described in the embodiments of FIGS. 1 and 2 above to produce condensates 15, 23 containing mixtures of TCS, STC, and dissolved HCl and a vapor component 24 containing a mixture of TCS, STC, HCl, and H₂. As in the embodiments of FIGS. 1 and 2, liquid N2 feeds 14, 18 produce vaporized N2 16, 20 for storage and/or onsite use as a sealant or coolant gas for reactor 5.

The vapor component 24 is directed to an adsorption unit 25 whereat an amount of H₂ is stripped. The stripped H₂ 31 is directed towards compressor 46 for eventual feeding to TCS reactors 41, 81. After stripping, the vapor component contains a major amount of gaseous HCl with minor amounts of STC and TCS. The “stripped” stream 29 is directed to condenser 33 where it is separated into HCl vapor 35 and condensate 34 containing a mixture of TCS and STC. The adsorption unit 25 is a thermal swing adsorbent (TSA) unit operated to separately recover H2, HCl, and chlorosilanes (TCS and STC).

Again referring to FIG. 3, HCl feed 39 comprised of HCl vapor 35 and make up HCl 37 is fed to TCS reactor 41 along with metallurgical grade Silicon (MG Si) feed 49 and optionally H2 compressed at compressor 46 supplemented with make up H2 45. While the rationale is not well understood, some have proposed that adding H2 at reactor 41 may enhance SiHCl3 production. The following reaction takes place at TCS reactor 41 (fluidized bed):

Si+3HCl→SiHCl3+H2

Typically silicon powder ground to an average particle size of about 100-200 μm is fed continuously under a N2 inerting blanket (obtained from cryogenic condensers 13, 21) to the reactor 41, where the reaction takes place at about 50 psig and 300° C.

STC feed 83 and MG Si feed 85 are fed to TCS reactor 81 along with H2 compressed at compressor 46 optionally supplemented with make up H2 87. The following reaction takes place at TCS reactor 81 in the presence of a CuCl catalyst:

Si+3SiCl4+2H2→4SiHCl3

Typically, the reactor 81 is maintained at a pressure and temperature of about 500 psig and 500° C.

TCS product stream 53 and TCS/STC product stream 55 are fed to purification unit 57 where a chlorosilane wash is used to condense any gaseous TCS and STC present and remove any undesired solid impurities at waste stream 61. TCS stream 73 comprising TCS stream 69 from purification unit 57 and condensates 15, 23 from condensers 13, 21 are fed to distillation unit 79 comprising one or more distillation columns.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for recycling effluent gas from a polysilicon production reactor, comprising the steps of:
directing an effluent gas from a polysilicon reactor to a gas separation unit comprising at least one gas separation membrane, said effluent gas comprising SiHCl₃, SiCl₄, HCl, and H₂;
recovering a recycle gas from a permeate side of the membrane, the recycle gas comprising H₂ permeated through the membrane from the effluent gas;
directing the recycle gas to the polysilicon reactor;
recovering a retentate gas from the membrane, the retentate gas comprising SiHCl₃, SiCl₄, HCl, and H₂; and
chilling the retentate gas at a first cryogenic condensation unit utilizing a liquid cryogen to absorb heat from the retentate gas thereby vaporizing at least a portion of the liquid cryogen and producing a first condensate comprising SiHCl3, SiCl4, and HCl from the retentate gas.

2. The method of claim 1, further comprising the step of directing the condensed SiHCl3, SiCl₄, and HCl to a SiHCl3 production process.

3. The method of claim 2, further comprising the steps of:
obtaining purified SiHCl3 from the SiHCl3 production process; and
directing a flow of the purified SiHCl3 towards the reactor.

4. The method of claim 1, wherein said step of chilling the retentate gas at a first cryogenic condensation unit comprises the step of chilling the retentate gas at a first cryogenic condenser to produce a first condensate comprising SiHCl3, SiCl4, and HCl.

5. The method of claim 4, further comprising the step of directing the first condensate to a SiHCl3 production process.

6. The method of claim 5, wherein said step of chilling the retentate gas at a first cryogenic condensation unit further comprises the steps of:
compressing a first non-condensate comprising a non-condensed portion of the retentate gas from the first cryogenic condenser, the first non-condensate comprising a majority of H2 and minor amounts of SiHCl3, SiCl4, and HCl; and
chilling the compressed first non-condensate at a second cryogenic condenser thereby producing a second condensate comprising SiHCl3, SiCl4, and HCl from the compressed first non-condensate.

7. The method of claim 6, further comprising the step of directing the second condensate from the second cryogenic condenser to a SiHCl3 production process.

8. The method of claim 7, further comprising the steps of:
obtaining purified SiHCl3 from the SiHCl3 production process; and
directing a flow of the purified SiHCl3 towards the reactor.

9. The method of claim 8, wherein the SiHCl3 production process comprises:
directing the first and second condensates to a distillation unit; and
obtaining the flow of purified SiHCl3 from the distillation unit.

10. The method of claim 9, wherein said SiHCl3 production process further comprises the steps of:
stripping H2 from a second non-condensate comprising a majority of H2 and a minor amount of SiHCl3, SiCl4, and HCl from a non-condensed portion of the compressed first non-condensate;
chilling the stripped second non-condensate to produce gaseous HCl and a third condensate comprising SiHCl3 and SiCl4; and
directing the third condensate to the distillation unit.

11. The method of claim 10, wherein said SiHCl3 production process further comprises the steps of:
feeding Si and the gaseous HCl to a first SiHCl3 reactor thereby producing impure SiHCl3;
purifying the impure SiHCl3 at a purification unit to produce a SiHCl3 feed;
directing the SiHCl3 feed to the distillation unit.

12. The method of claim 11, wherein the Si is fed to the first SiHCl3 reactor under a gaseous N2 blanket obtained from the first and/or second cryogenic condensers.

13. The method of claim 11, wherein said SiHCl3 production process further comprises the steps of:
feeding Si, H2, and a SiCl4-rich fraction from the distillation unit to a second SiHCl3 reactor in the presence of CuCl thereby producing impure SiHCl3; and
purifying the impure SiHCl3 from the second SiHCl3 reactor at the distillation unit.

14. The method of claim 1, further comprising the step of cooling the reactor with a portion of the vaporized liquid cryogen.

15. The method of claim 1, further comprising the step of blanketing the reactor with a portion of the vaporized liquid cryogen to reduce the infiltration of oxygen into the reactor.

16. The method of claim 3, wherein the purified SiHCl3 is stored in a storage vessel blanketed with vaporized liquid cryogen to reduce the infiltration of oxygen into the vessel.

17. A system for recycling effluent gas from a polysilicon production reactor, comprising:
a gas separation unit comprising at least one gas separation membrane, an inlet, a permeate outlet, and a retentate outlet, the inlet being adapted and configured to fluidly communicate with an effluent gas outlet of a polysilicon reactor, the permeate outlet being adapted and configured to fluidly communicate with a reactant feed inlet of the polysilicon reactor; and
a first cryogenic condenser having a permeate gas inlet, a liquid nitrogen inlet, a vaporized cryogen outlet, a condensate outlet, and a non-condensate outlet, the permeate gas inlet being in fluid communication with the retentate outlet, wherein the first cryogenic condenser is adapted and configured to cool effluent gas obtained from the retentate gas outlet by vaporizing liquid nitrogen from the liquid nitrogen inlet.

18. The system of claim 17, further comprising:
a compressor adapted and configured to receive a non-condensate from the non-condensate outlet of the first condenser; and
a second cryogenic condenser having non-condensate inlet, a liquid nitrogen inlet, a vaporized cryogen outlet, a condensate outlet, and a non-condensate outlet, the non-condensate inlet being in fluid communication with the compressor, wherein the second cryogenic condenser is adapted and configured to cool effluent gas from the compressor by vaporizing liquid nitrogen from the second condenser liquid nitrogen inlet.

19. The system of claim 18, further comprising:
a distillation unit having inlets in fluid communication with the condensate outlets of the first and second cryogenic condensers, the distillation unit being adapted and configured to provide a purified SiHCl3 feed to be directed to the reactor.

20. The system of claim 19, further comprising:
an adsorption unit adapted and configured to strip H2 from a SiCl4, SiHCl3, HCl, and H2 containing vapor from the non-condensate outlet of the second condenser;
a third cryogenic condenser having an inlet, a gaseous HCl outlet, and a condensate outlet, the third condenser inlet being adapted and configured to condense SiCl4 and SiHCl3 from a vapor from the adsorption unit;
a first SiHCl3 reactor having reactant inlets in fluid communication with a source of particulate Si and the gaseous HCl outlet;
a purification unit having an inlet and outlet, the purification unit inlet being adapted and configured to receive impure SiHCl3 from the first SiHCl3 reactor, the purification unit outlet being in fluid communication with an inlet of the distillation unit.

21. The system of claim 20, wherein the source of particulate Si is adapted and configured to receive a gaseous N2 blanket from first and/or second cryogenic condenser.

22. The system of claim 20, further comprising a second SiHCl3 reactor having reactant inlet and a product outlet, the second SiHCl3 reactor reactant inlet being in fluid communication with a source of particulate Si, a source of H2, and a SiCl4 outlet of the distillation unit, the second SiHCl3 reactor being adapted and configured to react Si and H2 from said sources with SiCl₄ from said SiCl4 outlet in the presence of CuCl to produce SiHCl3, the second SiHCl3 reactor product outlet being in fluid communication with an inlet of the distillation unit.
